(19) United States
(12) Patent Application Publication
(10) Pub. No.: US 2026/0185639 A1
(43) Pub. Date: Jul. 2, 2026

(54) ANCHOR FOR A WATERWAY ASSEMBLY

(71) Applicant: Delta Faucet Company, Indianapolis, IN (US)

(72) Inventors: William Blue, Middlefield, OH (US); Jay Burnett, Chagrin Falls, OH (US)

(21) Appl. No.: 19/413,124

(22) Filed: Dec. 9, 2025

Related U.S. Application Data
(60) Provisional application No. 63/740,938, filed on Dec. 31, 2024.

(51) Int. Cl. F16L 19/025

(52) U.S. Cl. CPC F16L 19/025

(57) ABSTRACT

A tube assembly includes a tube and a fluid coupler formed on a distal end of the tube. The fluid coupler includes an anchor defined by a ferrule supported by the distal end of the tube and cooperating with a coupling nut.

### CROSS-REFERENCE TO RELATED APPLICATION

The present application claims priority to U.S. Provisional Patent Application Ser. No. 63/740,938, filed Dec. 31, 2024, the disclosure of which is expressly incorporated herein by reference.

### BACKGROUND AND SUMMARY OF THE DISCLOSURE

The present invention relates generally to a fluid coupler for a tube and, more particularly, to a method of forming an anchor on a waterway assembly of a faucet and the fluid coupler formed thereby.

Molded waterway assemblies for use within fluid delivery devices, such as faucets, are known in the art. Such waterway assemblies may include a plurality of tube assemblies having a proximal end overmolded within a valve interface member and a distal end including a fluid coupler having an overmolded anchor.

Cross-linked polyethylene can be used in a variety of applications, including in plumbing systems such as the aforementioned waterway assemblies. Cross-linked polyethylene is often used as an alternative for polyvinyl chloride, chlorinated polyvinyl chloride, and metal in pipe systems, for example. Cross-linked polyethylene is a favorable material due to characteristics such as thermal resistance, cracking resistance, scratch resistance, and impact strength. In a typical method, a pipe, cable, or other article is formed from a polyethylene compound, such as high-density polyethylene or low-density polyethylene. Then, the article undergoes a cross-linking process, such as peroxide cross-linking, silane cross-linking, irradiation cross-linking, or azo cross-linking.

In connection with the above mentioned tube assemblies, a coupler or fastener such as a coupling nut may be disposed on the pipe or tubing to facilitate fluid coupling of the pipe or tubing to another component. In certain illustrative embodiments, the coupling nut must be disposed on the pipe or tubing before the cross-linking process. Otherwise, the coupling nut must be moved to ensure the entire pipe or tubing has been cross-linked. Such a process may lead to non-uniform cross-linking, resulting in non-uniform properties of the pipe or tubing. This manufacturing process may additionally be inconvenient and inefficient.

Additionally, installation of the coupling nut is often prevented after the proximal end of the pipe or tubing is installed in a fluid delivery device, such as a faucet. More particularly, the coupling nut is not configured to be slid over the fitting or collar at the distal end of the tubing. As such, there is a desire to provide a structure and method of installing a coupling nut on the distal end of a tube after cross-linking and/or installation of the proximal end in a fluid delivery device.

The present invention includes a fluid coupler or anchor that allows for coupling nuts to be installed after the tube assembly is inserted in a faucet spout.

According to an illustrative embodiment of the present disclosure, a tube assembly includes two collars overmolded onto a tube. A coupling nut is slipped over the collars. A retainer ring is then injected molded and crosslinked. The retainer ring is expanded and installed between the collars.

According to another illustrative embodiment of the present disclosure, a tube assembly includes a collar overmolded onto a tube. A coupling nut is slipped over the collar. A retainer sleeve is injection molded and crosslinked. The retainer sleeve is expanded and installed over the collar.

According to yet another illustrative embodiment of the present disclosure, a tube assembly includes a molded ferrule that is undersized on all diametrical dimensions. A ferrule is inserted into the nut and a molded expansion plug is then inserted into the ferrule, stretching its inner diameter. The expansion plug is then removed and the ferrule/nut assembly is assembled onto a tube.

According to an illustrative embodiment of the present disclosure, a tube assembly includes a tube formed of a polymer and including a proximal end and a distal end. A distal collar is overmolded with the tube at the distal end of the tube. A retaining ring is supported on the tube proximal of the distal collar. A coupling nut is slidably received on the tube and is axially retained by the retaining ring.

According to another illustrative embodiment of the present disclosure, a method of forming a tube assembly includes the steps of providing a tube having a proximal end and a distal end, and overmolding a distal collar on the distal end of the tube. The method further includes the steps of cross-linking the distal collar with the tube, positioning a retaining ring on the tube proximal of the distal collar, and sliding a coupling nut over the distal collar.

According to a further illustrative embodiment of the present disclosure, a tube assembly includes a tube formed of a polymer, the tube including an outer diameter, a proximal end and a distal end. A ferrule is supported on a distal end of the tube, the ferrule including an inner diameter less than the outer diameter of the tube defining an interference therebetween, wherein a hoop strength of the ferrule couples the ferrule to the tube. A coupling nut receives the ferrule and is slidable along the tube.

According to yet another illustrative embodiment of the present disclosure, a method of forming a tube assembly includes the steps of inserting a ferrule into a coupling nut, the ferrule including an inner diameter, inserting an expansion plug into the ferrule thereby expanding the inner diameter of the ferrule, and removing the expansion plug from the ferrule. The method further includes the steps of inserting a tube into the ferrule, the tube including an outer diameter less than the inner diameter of the ferrule, and wherein the inner diameter of the ferrule contracts such that the hoop strength of the ferrule retains the ferrule on the tube.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description of exemplary embodiments when taken in conjunction with the accompanying drawings, wherein:

FIG. 1 is a partial perspective view of an illustrative tube assembly of the present disclosure;

FIG. 2 is a cross-sectional view of the illustrative tube assembly taken along line 2-2 of FIG. 1;

FIG. 3 is an exploded perspective view of the illustrative tube assembly of FIG. 1;

FIG. 4 is a perspective view showing a step of an illustrative method of forming the tube assembly of FIG. 1;

FIG. 5 is a perspective view showing another step of the illustrative method of forming the tube assembly of FIG. 1;

FIG. 6 is a perspective view showing another step of the illustrative method of forming the tube assembly of FIG. 1;

FIG. 7 is a partial perspective view of a further illustrative tube assembly of the present disclosure;

FIG. 8 is a cross-sectional view of the illustrative tube assembly taken along line 8-8 of FIG. 7;

FIG. 9 is an exploded perspective view of the illustrative tube assembly of FIG. 7;

FIG. 10 is a perspective view showing a step of an illustrative method of forming the tube assembly of FIG. 7;

FIG. 11 is a perspective view showing another step of the illustrative method of forming the tube assembly of FIG. 7;

FIG. 12 is a perspective view showing another step of the illustrative method of forming the tube assembly of FIG. 7;

FIG. 13 is a perspective view of a further illustrative tube assembly of the present disclosure;

FIG. 14 is a cross-sectional view of the illustrative tube assembly taken along line 14-14 of FIG. 13;

FIG. 15 is an exploded perspective view of the illustrative tube assembly of FIG. 13;

FIG. 16 is a perspective view of illustrative tooling cooperating with a ferrule of the tube assembly of FIG. 13;

FIG. 17 is an exploded perspective view of the illustrative tooling of FIG. 16;

FIG. 18 is a cross-sectional view of the illustrative tooling of FIG. 16 during a method of forming the tube assembly of FIG. 13;

FIG. 19 is a cross-sectional view showing another step of the illustrative method of forming the tube assembly of FIG. 13; and

FIG. 20 is a cross-sectional view showing another step of the illustrative method of forming the tube assembly of FIG. 13.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

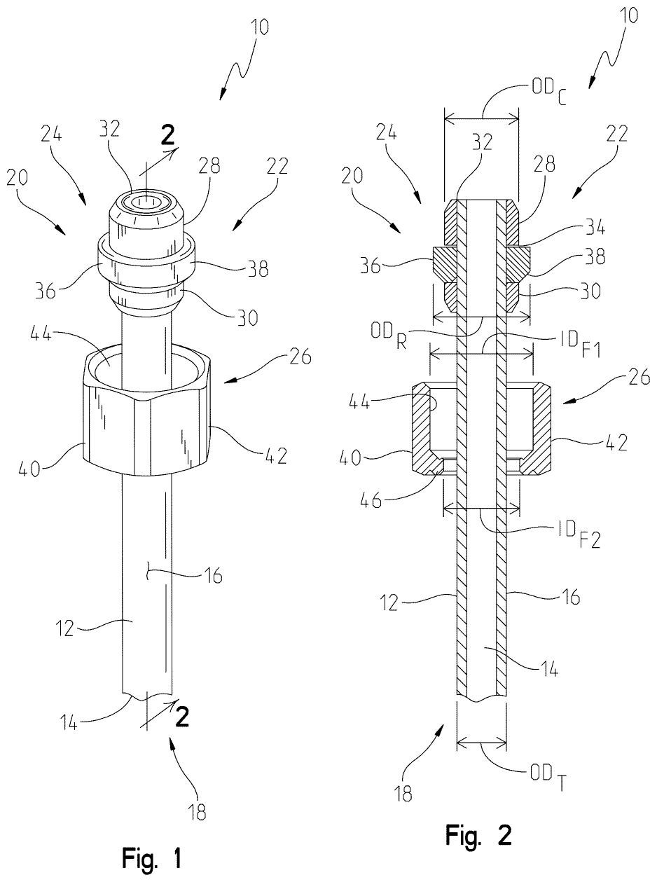

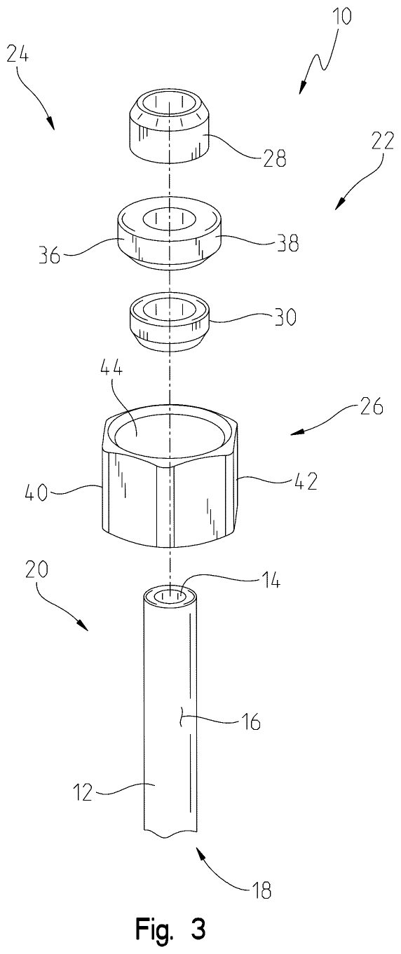

FIGS. 1-3 show a waterway or tube assembly 10 according to an illustrative embodiment of the present disclosure. The illustrative tube assembly 10 includes a fluid tube 12 having a fluid passageway 14. The fluid tube 12 includes a cylindrical outer surface 16 defining an outer diameter OD_{T} (illustratively, about 0.250 inches) extending between a proximal end 18 and a distal end 20. Illustratively, the fluid tube 12 is formed of a polymer, such as a polyethylene.

The proximal end 18 of the tube 12 is illustratively supported within a fluid delivery device, such as a faucet (not shown). For example, the proximal end 18 of the tube 12 may include an overmolded interface (not shown) for fluidly coupling with a valve assembly of the faucet. Illustrative waterway assemblies for use with faucets are disclosed in U.S. Pat. No. 7,766,043 to Thomas et al., and U.S. Published Patent Application Publication No. 2019/0085993 to Nelson et al., the disclosures of which are expressly incorporation herein by reference.

The distal end 20 of the tube 12 illustratively supports a fluid coupler 22 including an anchor or fitting 24 and a fastener 26. The fitting 24 illustratively includes a distal collar 28 and a proximal collar 30 formed of a polymer, such as a polyethylene. The distal collar 28 is illustratively overmolded with the tube 12 at the distal end 20 to define a planar end surface 32. The proximal collar 30 is illustratively overmolded with the tube 12 proximal of the distal collar 28 and in spaced relation thereto thereby defining a gap 34.

The distal collar 28 and the proximal collar 30 have an outer diameter OD_{C}, illustratively about 0.375 inches. A sealing member, such as an annular gasket (not shown), may also be supported on the distal end 20 of the tube 12.

The fitting 24 further includes a retaining ring 36 supported on the tube 12 proximal of the distal collar 28. Illustratively, the retaining ring 36 includes a ferrule 38 positioned intermediate the distal collar 28 and the proximal collar 30. The retaining ring 36 is illustratively formed of a polymer, such as a polyethylene, and has an outer diameter OD_{R}, illustratively greater than about 0.375 inches.

In an illustrative embodiment, the tube 12 and the fitting 24 are formed of a cross-linked polyethylene (PEX). For example, in manufacturing, the tube 12 and the fitting 24 are formed of a high-density polyethylene. In some illustrative embodiments, the tube 12 and the fitting 24 may be formed from a low density polyethylene. The tube 12 and the fitting 24 may then undergo the cross-linking process by a number a cross-linking methods, including peroxide cross-linking, silane cross-linking, eradiation cross-linking, and azo cross-linking. During the cross-linking process, cross-link bonds are formed within the polymer structure and can be completed to a varying degree depending on the desire of manufacturer and the purpose of the cross-link tube.

Crosslinking imparts shape memory properties to polymers. Shape memory materials have the ability to return from a deformed state (e.g. temporary shape) to their original crosslinked shape (e.g. permanent shape), typically induced by an external stimulus or trigger, such as a temperature change. Alternatively, or in addition to temperature, shape memory effects can be triggered by an electric field, magnetic field, light, or a change in pH, or even the passage of time.

With reference to FIGS. 1 and 2, the fastener 26 illustratively includes a coupling nut 40 having a body 42 with internal threads 44 and a retaining flange 46. The coupling nut 40 is illustratively formed of a metal, such as a plated brass. The body 42 has an inner diameter ID_{F1} and the retaining flange 46 has an inner diameter ID_{F2}. The inner diameter ID_{F1} is greater than the outer diameter OD_{R} of the retaining ring 36, and the inner diameter ID_{F2} is less than the outer diameter OD_{R} of the retaining ring 36.

As is known, the inner retaining flange 46 of the coupling nut 40 is configured to cooperate with the ferrule 38 to retain the nut 40 on the tube assembly 10. More particularly, the coupling nut 40 is retained on the tube assembly 10 by the retaining ring 36 since the inner diameter ID_{F2} of the retaining flange 46 is less than the outer diameter OD_{R} of the retaining ring 36.

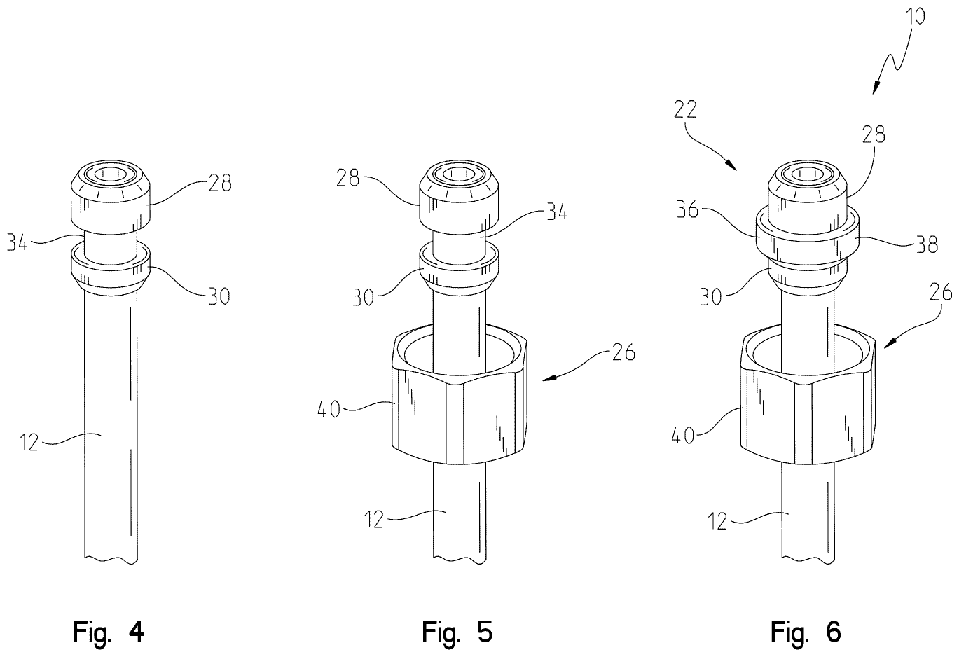

FIGS. 4-6 show an illustrative method of forming the tube assembly 10. The distal collar 28 and the proximal collar 30 are overmolded with the tube 12. The tube 12 and the collars 28, 30 are illustratively cross-linked together to define PEX. The coupling nut 40 is then slid over the collars 28, 30 and positioned on the tube 12 proximal of the proximal collar 30. The retaining ring 36 is illustratively molded from a polymer, illustratively polyethylene. The retaining ring 36 is then cross-linked to form PEX. The inner diameter of the retaining ring 36 is then expanded such that the retaining ring 36 is slid over the distal collar 28 and received within the gap 34 between the collars 28, 30.

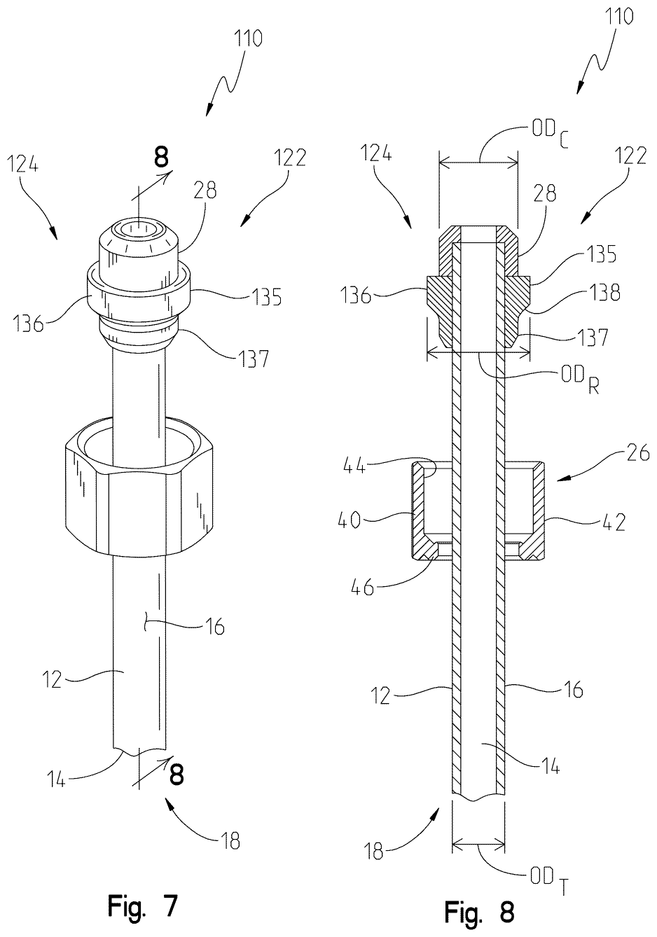

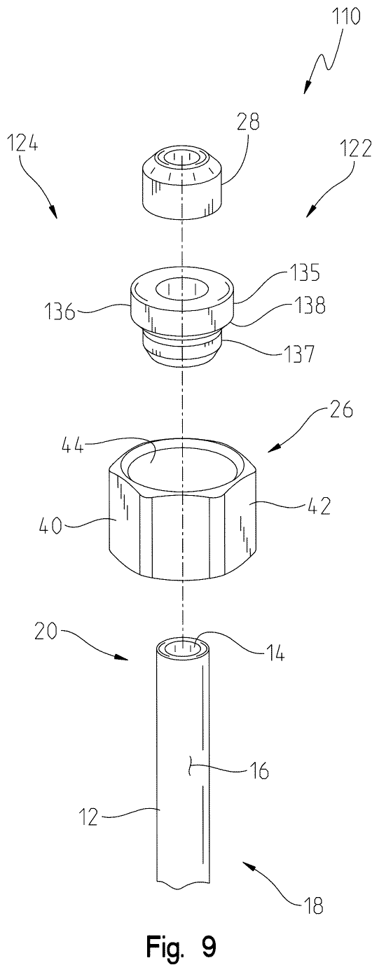

FIGS. 7-9 show a waterway or tube assembly 110 according to another illustrative embodiment of the present disclosure. Illustrative tube assembly 110 includes many similar elements of the tube assembly 10 detailed above. As such, in the following description like reference numbers identify similar components.

The tube assembly 110 includes a fluid coupler 122 having an anchor or fitting 124 and the fastener 26. The fitting 124 illustratively includes the distal collar 28 and a retaining ring 136. The retaining ring 136 illustratively includes a distal portion 135 and a proximal portion 137. The distal portion 135 illustratively includes a ferrule 138 having an outer diameter OD_{R}, illustratively greater than 0.375 inches. The proximal portion 137 illustratively has an outer diameter OD_{C}, illustratively about 0.375 inches.

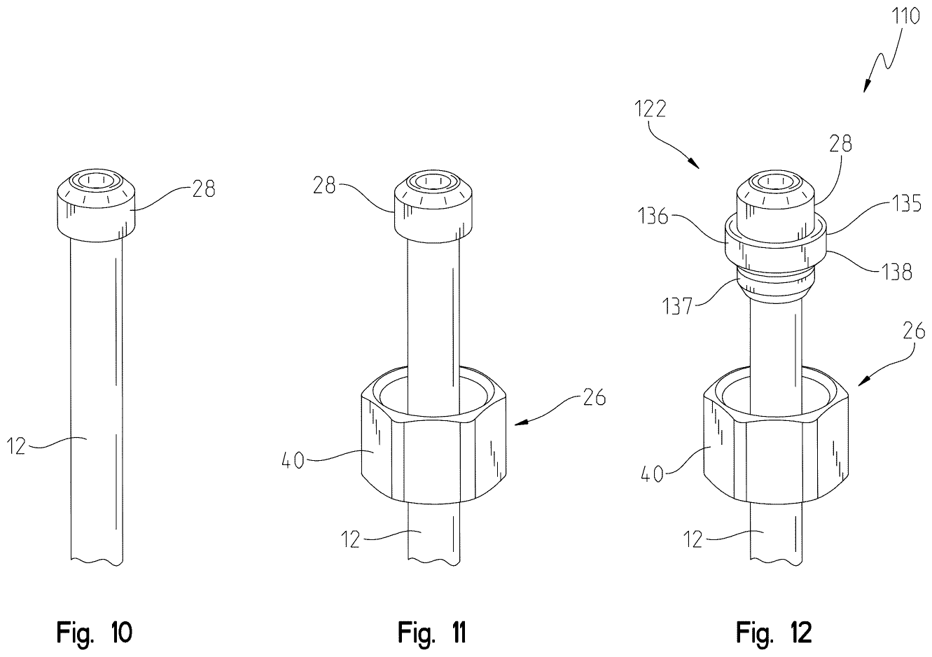

FIGS. 10-12 show an illustrative method of forming the tube assembly 10. The distal collar 28 is overmolded with the tube 12. The tube 12 and the collar 28 is illustratively cross-linked together to define PEX. The coupling nut 40 is then slid over the collar 28 and positioned on the tube 12 proximal of the collar 28. The retaining ring 136 is illustratively molded from a polymer, such as a polyethylene. The retaining ring 136 is then cross-linked. The inner diameter of the retaining ring 136 is then expanded such that the retaining ring 136 is slid over the distal collar 28 and received on the tube 12 proximal of the collar 28. Illustratively, the residual hoop strength of the retaining ring 136 secures the retaining ring 136 on the tube 12.

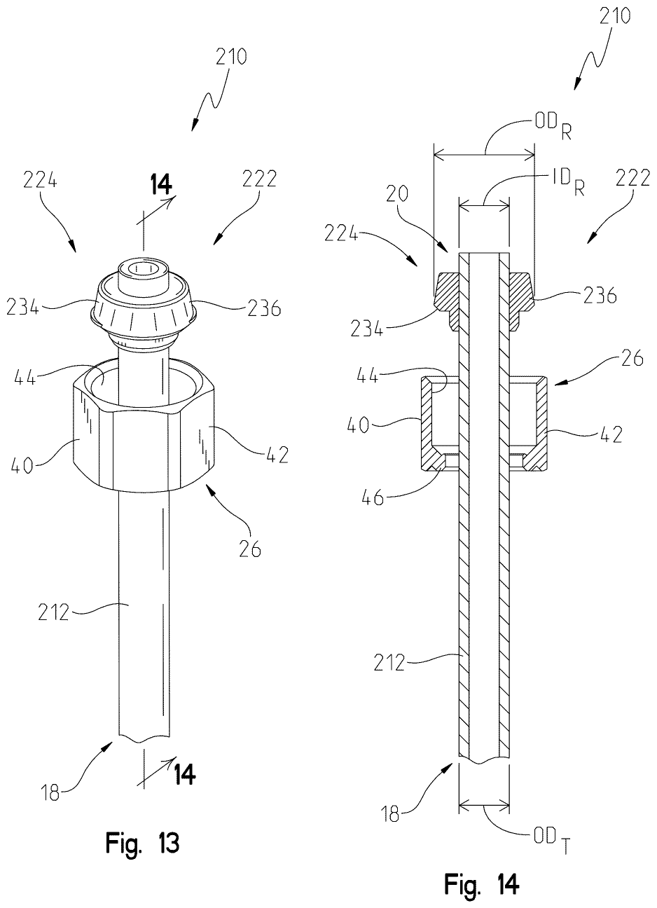

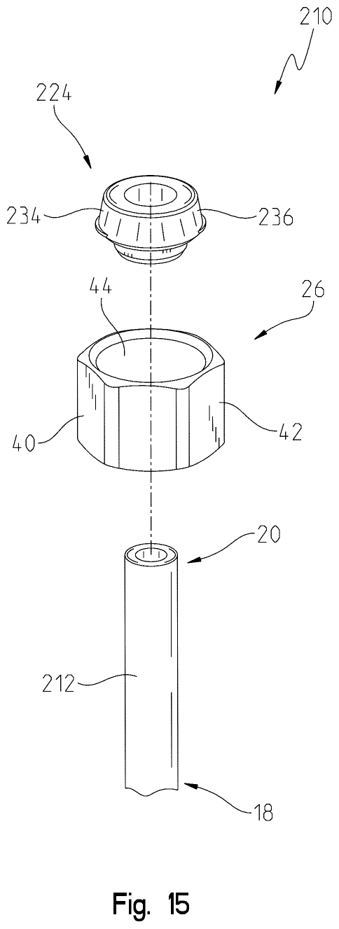

FIGS. 13-15 show a waterway or tube assembly 210 according to a further illustrative embodiment of the present disclosure. Illustrative tube assembly 210 includes many similar elements of the tube assembly 10 detailed above. As such, in the following description like reference numbers identify similar components.

The tube assembly 210 illustratively includes a tube 212 similar to the tube 12 further detailed above. The outer diameter OD_{T} of the tube 212 is illustratively about 0.375 inches. The illustrative tube assembly 210 includes a fluid coupler 222 having an anchor or fitting 224 and the fastener 26. The fitting 224 illustratively a retaining ring 234 supported by the distal end 20 of the tube 12 and including a ferrule 236 having an inner diameter ID_{R}, illustratively about 0.350 inches. The ferrule 236 is illustratively molded from a polymer, such as a polyethylene, which is cross-linked.

The ferrule 236 illustratively has an outer diameter OD_{R}, illustratively about 0.375 inches. The inner diameter ID_{R} of the ferrule 236 is illustratively undersized relative to the tube 12. Illustratively, the ID_{R} is about 0.350 while the outer diameter OD_{T} of the tube 212 is about 0.375. As such, the ferrule 236 has an interference fit on the tube 212 wherein a hoop strength of the ferrule 236 retains the fitting 224 on the tube assembly 210.

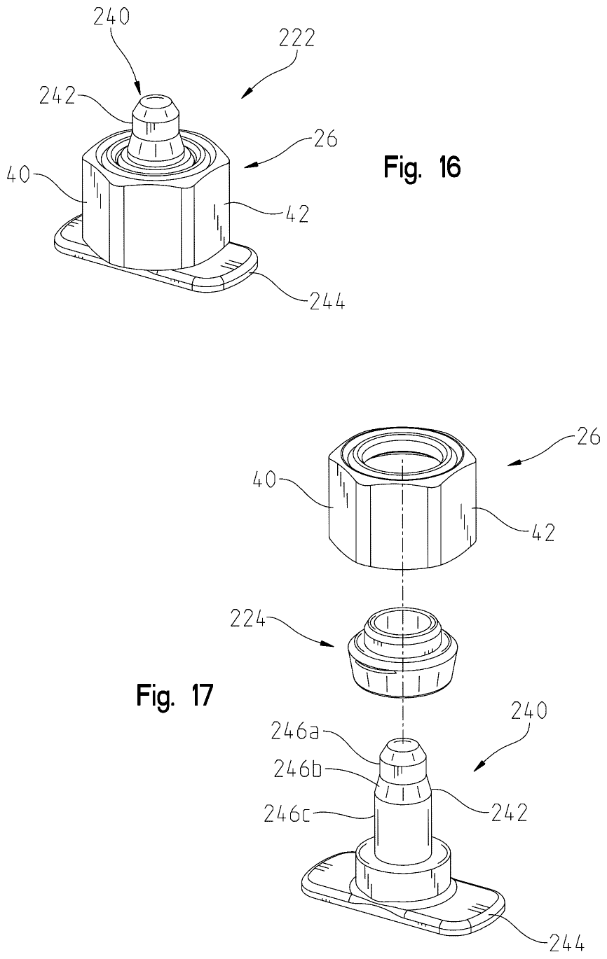

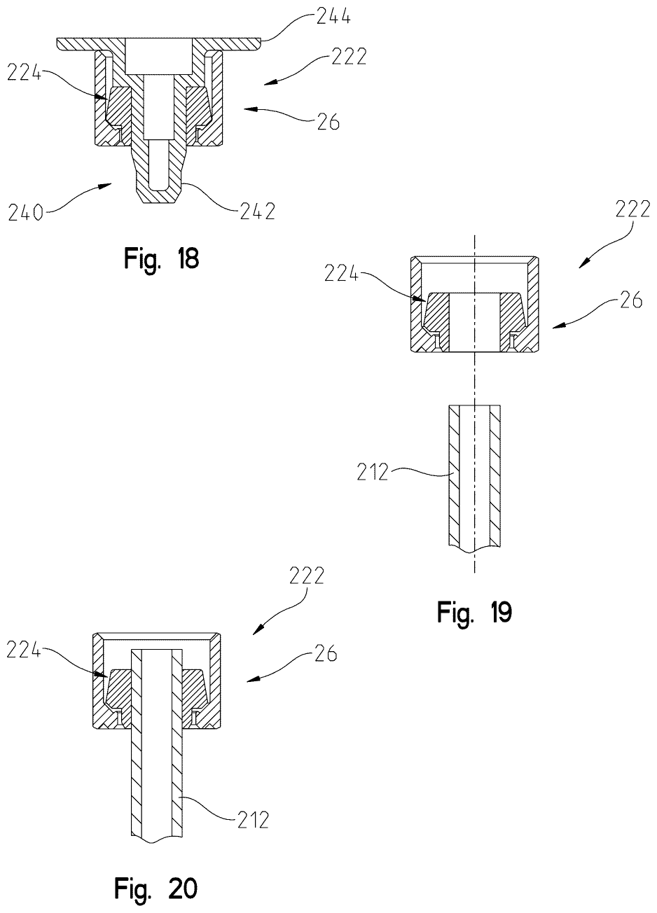

With reference to FIGS. 16-20, a tool in the form of an expansion plug 240 is used in an illustrative method of forming the tube assembly 210. The expansion plug 240 is illustratively molded from a polymer and includes a protrusion 242 supported by a base 244. The protrusion 242 includes a plurality of cylindrical steps 246a, 246b, 246c of increasing outer diameters.

The ferrule 236 is inserted into the coupling nut 40 and the expansion plug 240 is then inserted into the ferrule 236, stretching its inner diameter ID_{R}. The expansion plug 240 is then removed and the coupler (ferrule/nut assembly) 222 is assembled onto the tube 212. The inner diameter ID_{R} has been expanded to be greater than the OD_{T} of the tube 212, such that the tube 212 may be inserted into the ferrule 236. Due to the residual hoop strength of the ferrule 236, the inner diameter ID_{R} of the ferrule 236 contracts such that it interferes with the OD_{T} of the tube 212. The ferrule 236 is thereby retained on the tube 212.

As used in the present application, the term “overmold” means the process of injection molding a second polymer over a first polymer, wherein the first and second polymers may or may not be the same. In one illustrative embodiment, the composition of the overmolded polymer may be such that it is capable of at least some melt fusion with the polymeric tube. There are several means by which this may be affected. One of the simplest procedures is to ensure that at least a component of the polymeric tube and that of the overmolded polymer is the same. Alternatively, it would be possible to ensure that at least a portion of the polymer composition of the polymeric tube and that of the overmolded polymer is sufficiently similar or compatible so as to permit the melt fusion or blending or alloying to occur at least in the interfacial region between the exterior of the polymeric tube and the interior region of the overmolded polymer.

Although the invention has been described in detail with reference to certain preferred embodiments, variations and modifications exist within the spirit and scope of the invention as described and defined in the following claims.

What is claimed is:

1. A tube assembly comprising:
a tube formed of a polymer, the tube including a proximal end and a distal end;
a distal collar overmolded with the tube at the distal end of the tube;
a retaining ring supported on the tube proximal of the distal collar; and
a coupling nut slidably received on the tube and axially retained by the retaining ring.

2. The tube assembly of claim 1, wherein an inner diameter of the coupling nut is greater than an outer diameter of the distal collar, and the inner diameter of the coupling nut is less than an outer diameter of the retaining ring.

3. The tube assembly of claim 2, further comprising a proximal collar overmolded with the tube proximal of the retaining ring.

4. The tube assembly of claim 3, wherein the inner diameter of the coupling nut is greater than an outer diameter of the proximal collar.

5. The tube assembly of claim 3, wherein the retaining ring is positioned intermediate the distal collar and the proximal collar.

6. The tube assembly of claim 1, wherein the distal collar is cross-linked with the tube.

7. The tube assembly of claim 1, wherein the retaining ring includes a distal portion and a proximal portion, and an outer diameter of the distal portion is greater than an outer diameter of the proximal portion.

8. A method of forming a tube assembly, the method comprising the steps of:
providing a tube including a proximal end and a distal end;
overmolding a distal collar on the distal end of the tube;
cross-linking the distal collar with the tube;
positioning a retaining ring on the tube proximal of the distal collar; and
sliding a coupling nut over the distal collar.

9. The method of claim 8, wherein an inner diameter of the coupling nut is greater than an outer diameter of the distal collar, and the inner diameter of the coupling nut is less than an outer diameter of the retaining ring.

10. The method of claim 8, further comprising the step of overmolding a proximal collar with the tube proximal of the retaining ring.

11. The method of claim 10, wherein the inner diameter of the coupling nut is greater than an outer diameter of the proximal collar.

12. The method of claim 10, wherein the retaining ring is positioned intermediate the distal collar and the proximal collar.

13. The method of claim 8, wherein the retaining ring includes a distal portion and a proximal portion, and an outer diameter of the distal portion is greater than an outer diameter of the proximal portion.

14. The method of claim 8, wherein the retaining ring is a molded polymer.

15. A tube assembly comprising:
a tube formed of a polymer, the tube including an outer diameter, a proximal end and a distal end;
a ferrule supported on a distal end of the tube, the ferrule including an inner diameter less than the outer diameter of the tube defining an interference therebetween, wherein a hoop strength of the ferrule retains the ferrule on the tube; and
a coupling nut receives the ferrule and is slidably supported on the tube.

16. The tube assembly of claim 15, wherein an inner diameter of the coupling nut is less than an outer diameter of the ferrule.

17. The tube assembly of claim 15, wherein the tube is formed of a polymer, and the ferrule is formed of a polymer.

18. A method of forming a tube assembly, the method comprising the steps of:
inserting a ferrule into a coupling nut, the ferrule including an inner diameter;
inserting an expansion plug into the ferrule thereby expanding the inner diameter of the ferrule;
removing the expansion plug from the ferrule;
inserting a tube into the ferrule, the tube including an outer diameter less than the inner diameter of the ferrule; and
wherein the inner diameter of the ferrule contracts such that the hoop strength of the ferrule retains the ferrule on the tube.

19. The method of claim 18, wherein an inner diameter of the coupling nut is less than an outer diameter of the ferrule.

20. The method of claim 18, wherein the tube is formed of a polymer, and the ferrule is formed of a polymer.

21. The method of claim 20, wherein the ferrule and the tube are crosslinked.
